(19) United States
(12) Patent Application Publication
(10) Pub. No.: US 2009/0029098 A1
(43) Pub. Date: Jan. 29, 2009

(54) Resin Composition for Improved Slit Film

(75) Inventors: John Ashbaugh, Houston, TX (US); William R. Wheat, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/175,709

(22) Filed: Jul. 18, 2008

Related U.S. Application Data
(60) Provisional application No. 60/961,449, filed on Jul. 23, 2007.

(51) Int. Cl. D03D 15/00; C08L 23/16; D03D 27/00; C08K 3/00; C08K 5/101; C08L 23/00; C08F 297/00

(52) U.S. Cl. 428/95; 525/240; 442/181; 524/451; 524/396; 524/536; 525/53

(57) ABSTRACT

Slit films and processes of forming the same are generally described herein. In one embodiment, the slit films include an impact copolymer (ICP) formed of polypropylene and less than about 8 wt. % total ethylene, wherein the slit film exhibits less shrinkage and higher tenacity than a slit film formed from an ICP having greater than 10 wt. % ethylene. In one embodiment, the slit films include an impact copolymer including propylene and ethylene, wherein the slit film is absent another polymer.

### CROSS-REFERENCE TO RELATED APPLICATIONS

This application claims the benefit of U.S. Provisional Patent Application Ser. No. 60/961,449, filed Jul. 20, 2007.

### FIELD

Embodiments of the present invention generally relate to polymer compositions useful for the formation of slit films.

### BACKGROUND

Heterophasic copolymers (impact copolymers (ICP)) are generally used in applications requiring impact strength, such as molding. While these polymers are well suited for molded articles, such polymers have not been widely used in the manufacture of films or fibers, such as slit film fibers, monofilaments or multifilament yarns, for example.

Block copolymers (formed by preparation of a preblock by polymerization of propylene, contacting the preblock with additional propylene and ethylene, added at separate inlets, to form post blocks in desired proportions) have been used for slit film production. However, such products generally experience shrinkage and are softer than products formed with propylene homopolymers. Therefore their use has been restricted to applications not affected by these differences, such as artificial turf formation.

Alternatively, homopolymers of propylene have been used for the production of slit films. Such homopolymers may be modified with a conventional propylene based impact copolymer (e.g., having an ethylene content of at least 10 wt. %), but such processes are generally expensive.

Therefore, a need exists to develop a cost-effective polymer for use in slit film, and in particular, for use in carpet applications, that experiences processing and property benefits, while not experiencing shrinkage.

### SUMMARY

Embodiments of the present invention include slit films.

In one embodiment, the slit films include an impact copolymer (ICP) formed of polypropylene and less than about 8 wt. % total ethylene, wherein the slit film exhibits less shrinkage and higher tenacity than a slit film formed from an ICP having greater than 10 wt. % ethylene.

In one embodiment, the slit films include an impact copolymer including propylene and ethylene, wherein the slit film is absent another polymer.

Embodiments of the invention further include woven articles formed from the slit films.

Embodiments further include processes of forming the slit films. In one embodiment, such processes generally include introducing propylene monomer to a first reaction zone, contacting the propylene monomer with a catalyst system to form a propylene homopolymer, passing the propylene homopolymer to a second reaction zone and contacting the propylene homopolymer with ethylene monomer and propylene monomer in the presence of a second catalyst system to form an impact copolymer including less than about 8 wt. % ethylene. The process further includes forming the impact copolymer into a slit film.

### BRIEF DESCRIPTION OF DRAWINGS

FIG. 1 illustrates the number of breaks at varying draw ratios of various polymer samples.

FIG. 2 illustrates the maximum tenacity at varying draw ratios of various polymer samples.

FIG. 3 illustrates the tenacity at varying draw ratios of various polymer samples.

FIG. 4 illustrates the elongation at varying draw ratios of various polymer samples.

FIG. 5 illustrates the number of shrinkage at varying draw ratios of various polymer samples.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

Embodiments of the invention generally include heterophasic polymers and processes of forming the same. As used herein, the term “heterophasic” generally refers to a polymer having two or more phases. The incorporation of the rubber phase into the polymer matrix generally improves impact properties. As a result, the heterophasic polymers may also be referred to as impact copolymers herein.

Embodiments generally relate to slit films formed from impact copolymers. The impact copolymers are formed from a plurality of olefin monomers.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems or combinations thereof, for example. As is known in the art, the catalysts may be activated for subsequent polymerization and may or may not be associated with a support material. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through n bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705 U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing a plurality of olefin monomers to form impact copolymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include ethylenically unsaturated monomers, C₄ to C₁₈ diolefins conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. As is known to one skilled in the art, the processes may include a plurality of reaction zones within a process, such as a plurality of gas phase reactors. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999. U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen (or other chain terminating agents, for example) may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such as stirred reactors in series, parallel or combinations thereof, for example.

In one or more embodiments, the impact copolymers are formed by incorporating a rubber fraction into the polymer matrix by methods known to one skilled in the art, such as via mechanical blending or co-polymerization, for example. The co-polymerization process may include at least two stages, wherein a first homopolymer (such as propylene) is produced in a first reaction zone, the product of which is transferred to a second reaction zone for contact with a comonomer and additional first monomer to produce the rubber component of the polymer.

In one embodiment, the homopolymer is polypropylene, while the comonomer is ethylene.

Upon removal from the reaction zones, the polymer may be passed to a polymer recovery system for further processing, such as addition of additives and/or extrusion, for example.

In one embodiment, the polymers are contacted with one or more additives. The additives may include additives known to one skilled in the art, such as stabilizers, antioxidants, nucleators, such as sodium benzoate or talc, neutralizers, anti-static agents, lubricants and fillers, for example.

The contact may occur as is known to one skilled in the art, such as via melt blending, for example. It is to be noted that the processes described herein generally occur in the absence of blending with additional polyolefin, such as additional propylene homopolymer.

### Polymer Product

The polymers (and blends thereof) formed via the processes described herein include impact copolymers. The impact copolymers include, but are not limited to, polypropylene copolymers, for example.

For example, the first phase of the polymer may include a homopolymer, such as polypropylene. Unless otherwise specified, the term propylene homopolymers include those polymers composed primarily of propylene and limited amounts of other comonomers, such as ethylene, wherein the comonomer makes up less than about 2 wt. % (e.g., mini random copolymers), or less than about 0.5 wt. % or less than about 0.1 wt. % by weight of polymer. In one embodiment, the impact copolymer includes at least 80 wt. % homopolymer or at least about 85 wt. % homopolymer, for example.

The second phase generally includes a rubber phase, such as ethylene-propylene rubber (EPR), for example. The rubber phase may be incorporated into the homopolymer phase by methods known to one skilled in the art. For example, additional ethylene and propylene may be fed to a reaction zone (such as a gas phase reactor) downstream of a first reaction zone used to form the homopolymer.

Embodiments generally utilize a lower comonomer level than that used in traditional impact copolymers. For example, traditional ICP's may have comonomer levels of about from about 9 wt. % to about II wt. %, while the ICP's of the present invention generally have comonomer levels of about 8 wt. % or less, or about 7 wt. % or less or about 6 wt. % or less, for example. As a result, the formed slit films are neither subject to detrimental shrinkage nor excessive softness versus propylene homopolymer materials.

Unless otherwise designated herein, all testing methods are the current methods at the time of filing.

In one embodiment, the polymers have a xylene solubles level of less than about 15 wt. %, or less than about 12 wt. % or less than about 10 wt. %, for example.

In one embodiment, the polymers have a melt flow rate (as measured by ASTM 1238) of from about 1 dg/min. to about 6 dg/min. or from about 1.5 dg/min. to about 5 dg/min., for example.

In one embodiment, the polymers have a molecular weight distribution (Mw/Mn) of from about 4 to about 15, or from about 4 to about 7 or from about 7 to about 15, for example.

### Product Application

The polymers and blends thereof are useful in applications known to one skilled in the art, Such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

In one embodiment, the polymers are used for slit film, such as tapes and/or direct extrusion of monofilaments. As used herein, the term “slit film” is used to refer to both slit film tape applications, as described herein, and monofilament fiber applications, as described herein. Slit film tapes may be used in applications such as carpet backing, industrial-type bags, sacks or wraps, ropes or cords, artificial grass and geotextiles, for example. In addition, slit film tapes and/or monofilaments may be used in other woven materials or fabrics. Therefore, it is beneficial that slit film tapes process easily in extrusion and orientation. It is further beneficial if the slit film tapes perform well to survive the operations of beaming and/or weaving and/or further downstream processes like heat-setting and/or coating, for example. It is also beneficial if the slit film tapes are resistant to breakage during all phases of the life of the tape, including manufacturing, weaving and in the final fabric. Slit film processes generally include melt blending the polymer within an extruder and passing such through a die to form a layer of film. Upon extrusion, the film may be quenched, such as via a water bath. After quenching, the film is slit longitudinally into one or more tape segments or slit film tapes. The slit film tapes are then heated and drawn or stretched in the machine or longitudinal direction. After the tapes are drawn, they may be annealed in an annealing oven, for example.

Monofilaments may be formed by melting and mixing polymers and feeding the melt through tiny holes, forming a line, which is then potentially drawn in the machine direction and wound onto spools of various thicknesses, for example.

In one specific embodiment, the polymers are used for carpet manufacturing. The slit film tapes can be used in both primary and secondary carpet backing for carpet construction. For example, the slit film tapes may be used to form a primary backing material in which the slit film tapes are woven together. Face carpet fibers or yarn are then tufted through this primary backing material. A secondary layer of backing material may also be formed from slit film tapes, which may be interlaced or combined with other fibers. The secondary layer of backing material is positioned against the undersurface of the primary backing opposite the face fibers and is usually joined thereto by a layer of adhesive sandwiched therebetween.

The embodiments of the invention are expected to result in a slit film product that does not experience detrimental water carryover in that process (water carryover from the quench bath generally causes uneven stretching in the drawing oven and increased tape breaks).

### EXAMPLES

The following examples illustrate a comparison between slit films formed from a variety of polymer samples. Polymer “A” is an impact copolymer having an ethylene content of about 6 wt. % and a melt flow rate of about 2.0 dg/min. Polymer “B” is a propylene homopolymer having a melt flow rate of 4.1 dg/min. and commercially available from TOTAL, Petrochemicals USA, Inc. as 3462. Polymer “C” is a nucleated impact copolymer having an ethylene content of 9 wt. %, a melt flow rate of about 1.3 dg/min. and is commercially available from TOTAL Petrochemicals USA, Inc. as 4280W. Polymer “D” is a blend of 50 wt. % Polymer B and 50 wt. % Polymer C. Polymer “E” is an impact copolymer having an ethylene content of 12 wt. %, a melt flow rate of about 20 dg/min. and is commercially available from TOTAL Petrochemicals USA, Inc. as 5724.

Each polymer sample was run on a Bouligny slit film tape line to form oriented slit film tapes.

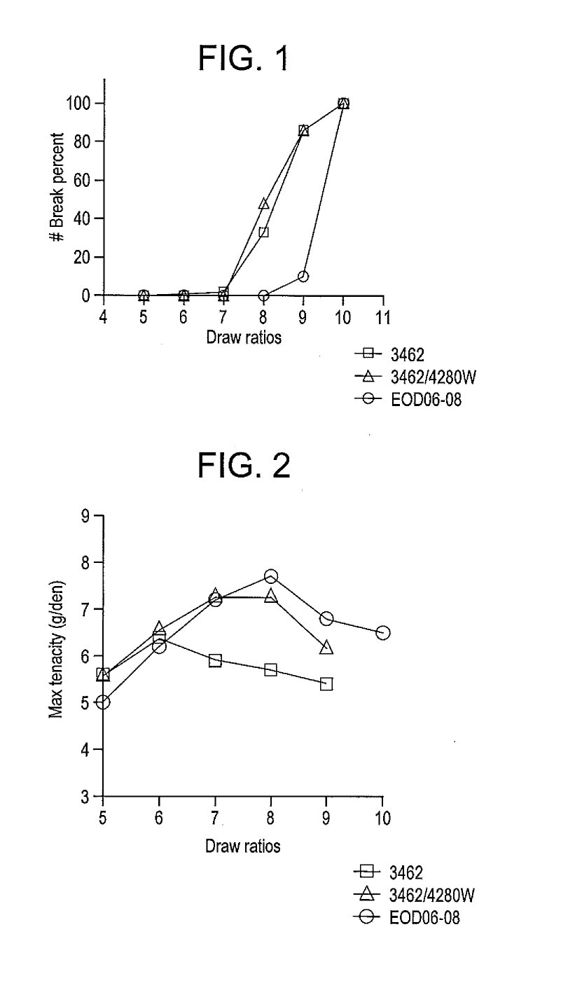

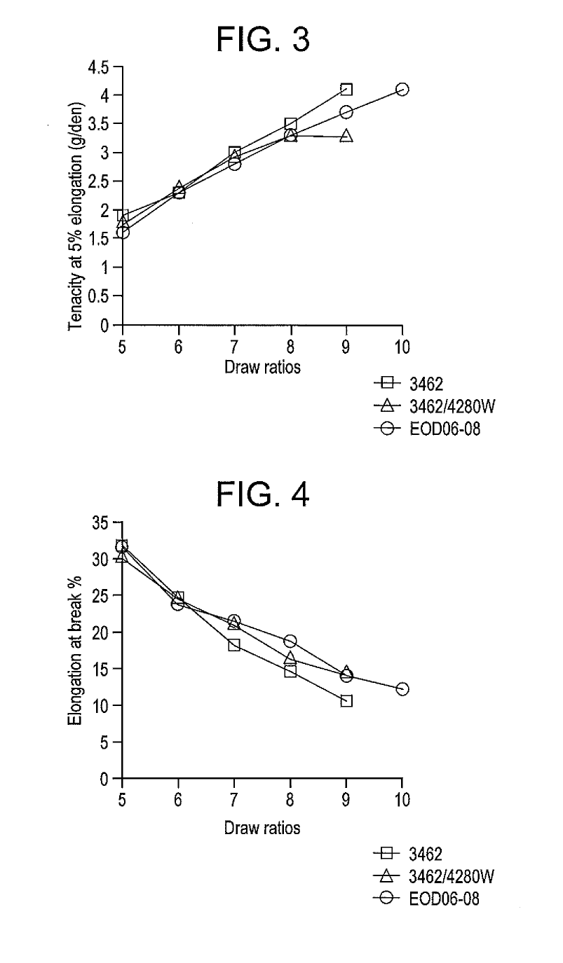

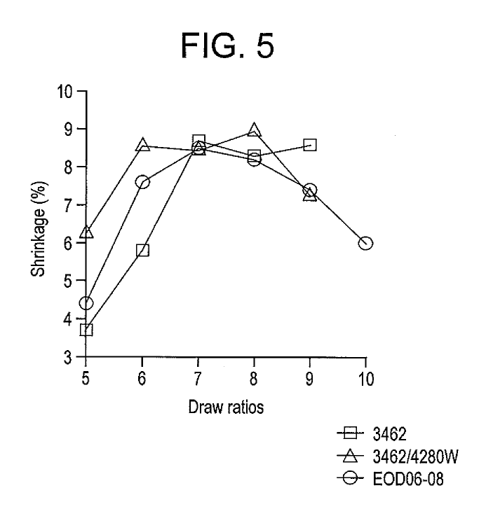

It was observed that the homopolymer (Polymer B) and the blend (Polymer D) exhibited comparable drawability, as evidenced by FIGS. 1 through 5. However, it was observed that Polymer A experienced fewer tape breaks than the other polymers at higher draw ratios. See, FIG. 1. In addition, Polymer A exhibited increased strength (as demonstrated by high tenacities and high elongation as measured by ASTM D638) over the other polymers sampled. See, FIGS. 2 through 4. It was further observed that Polymer A experienced less shrinkage than the other polymers. See, FIG. 5. In addition, it was observed that Polymer E resulted in a lower tenacity than polymers formed with less than 10 wt. % ethylene (e.g., Polymer E exhibited a maximum tenacity at a draw ratio of 5:1 of 2.8 compared to the tenacity of 5 or greater of Polymers A, B and D). Polymer E further exhibited an elongation at break of 27.2% and a shrinkage of 9.6%.

While the foregoing is directed to embodiments of the present invention, other and further embodiments of the invention may be devised without departing from the basic scope thereof and the scope thereof is determined by the claims that follow.

What is claimed is:

1. A slit film comprising:
an impact copolymer (ICP) comprising polypropylene and less than about 8 wt. % total ethylene, wherein the slit film exhibits less shrinkage and higher tenacity than a slit film formed from an ICP having greater than 10 wt. % ethylene.

2. The slit film of claim 1, wherein the impact copolymer comprises greater than about 80 wt. % polypropylene homopolymer.

3. A woven article formed by the slit film of claim 1.

4. The woven article of claim 3, further comprising carpet backing.

5. The slit film of claim 1, further comprising one or more additives selected from anti-oxidants, neutralizers, nucleators, talc, sodium benzoate and combinations thereof.

6. The slit film of claim 1, wherein the impact copolymer is formed by a copolymerization process.

7. The slit film of claim 1, wherein the impact copolymer comprises a molecular weight distribution of from about 4 to about 15.

8. The slit film of claim 1, wherein the slit film is adapted to reduce water carryover.

9. The slit film of claim 1, wherein the impact copolymer exhibits a melt flow rate of from about 1 dg/min. to about 6 dg/min.

10. A slit film comprising:
an impact copolymer comprising propylene and ethylene, wherein the slit film is absent another polymer.

11. The slit film of claim 10, wherein the impact copolymer comprises greater than about 80 wt. % polypropylene homopolymer.

12. The slit film of claim 10, further comprising one or more additives selected from anti-oxidants, neutralizers, nucleators, talc, sodium benzoate and combinations thereof.

13. The slit film of claim 10, wherein the impact copolymer is formed by a copolymerization process.

14. The slit film of claim 10, wherein the impact copolymer comprises a molecular weight distribution of from about 4 to about 15.

15. The slit film of claim 10, wherein the impact copolymer comprises less than about 8.0 wt. % ethylene.

16. A process of forming a slit film comprising:
introducing propylene monomer to a first reaction zone,
contacting the propylene monomer with a catalyst system to form a propylene homopolymer;
passing the propylene homopolymer to a second reaction zone;
contacting the propylene homopolymer with ethylene monomer and propylene monomer in the presence of a second catalyst system to form an impact copolymer comprising less than about 8 wt. % ethylene;
forming the impact copolymer into a slit film.

17. The process of claim 16, wherein the second reaction zone is a gas phase reactor.
